(19) United States
(12) Patent Application Publication
(10) Pub. No.: US 2018/0026762 A1
(43) Pub. Date: Jan. 25, 2018

(54) Methods and Apparatus for Coordination of Wireless Network Communication

(71) Applicant: Nokia Technologies Oy, Espoo (FI)

(72) Inventors: Hossein-Ali SAFAVI-NAEINI, Schereville, IN (US); Sayantan CHOUDHURY, Berkeley, CA (US)

(73) Assignee: Nokia Technologies Oy, Espoo (FI)

(21) Appl. No.: 15/547,981

(22) PCT Filed: Feb. 6, 2015
(86) PCT No.: PCT/IB2015/050916

§ 371 Date: Aug. 1, 2017

(51) Int. Cl. H04L 5/00; H04W 72/04

(52) U.S. Cl. CPC H04L 5/0007; H04L 5/0032; H04L 5/0053; H04W 72/0446; H04W 84/12

(57) ABSTRACT

Systems and techniques for coordinating wireless local area networking communication. An access point capable of OFDMA communication transmits to one or more stations capable of synchronous communication. Each communication frame transmitted on the uplink or downlink includes information, such as OFDM header information, Morming legacy stations not to transmit during the OFDMA transmission. The header information may be a legacy header prepended by the access point for downlink transmission, or a portion of a legacy header prepended by each of a plurality of stations for uplink transmission, with the portions being concatenated into a complete header during a simultaneous transmission. Alternatively, the header information may be a header transmitted by a designated group leader during a simultaneous transmission.

### FIELD OF THE INVENTION

The present invention relates generally wireless communication. More particularly, the invention relates to improved systems and techniques for multiple access wireless local area networking communication.

### BACKGROUND

Wireless local area networking (often referred to as WLAN or Wifi) applications have become increasingly widespread, and serve as an important communications portal. Wireless local area networks may serve home and business users of networks established for a specific group of users and other wireless local area networks users of publicly accessible networks that may be open to all users or through paid or no-cost subscriptions. The number of Wifi users continues to increase and the data needs of such users also continues to increase. Increases in the efficiency and capacity of Wifi networks benefit large numbers of operators and users.

### SUMMARY OF THE INVENTION

In one embodiment of the invention, an apparatus comprises at least one processor and memory storing a program of instructions. The memory storing the program of instructions is configured to, with the at least one processor, cause the apparatus to at least define at least first and second communication frames for transmission in at least first and second frequency sub-bands, respectively, the at least first and second frequency sub-bands being encompassed within a frequency band, each of the first and second frames comprising a duration field specifying a time duration during which an orthogonal frequency division multiplexing device is to refrain from accessing the sub-bands in which the at least first and second frames are transmitted; define an additional communication frame for transmission in a portion of the frequency band comprising all of the at least first and second frequency sub-bands, transmit the at least first and second frames using an orthogonal frequency division multiplexing technique; and transmit the additional frame using an orthogonal frequency division multiple access technique.

In another embodiment of the invention, an apparatus comprises at least one processor and memory storing a program of instructions. The memory storing the program of instructions is configured to, with the at least one processor, cause the apparatus to at least receive at least first and second frames transmitted by an access point in at least first and second frequency sub-bands, respectively, the at least first and second frequency sub-bands being encompassed within a frequency band, each of the first and second frames comprising a duration field specifying a time duration during which an orthogonal frequency division multiplexing device is to refrain from accessing the sub-bands in which the at least first and second frames are transmitted, and receive an additional frame transmitted in a portion of the frequency band comprising all of the at least first and second frequency sub-bands during the duration specified by the duration field, such that transmission of the communication frame is protected from interference by orthogonal frequency division multiplexing devices. The first and second frames are transmitted using an orthogonal frequency division multiplexing technique and wherein the additional frame is transmitted using orthogonal frequency division multiple access techniques.

In another embodiment of the invention, an apparatus comprises at least one processor and memory storing a program of instructions. The memory storing the program of instructions is configured to, with the at least one processor, cause the apparatus to at least use orthogonal frequency division multiple access techniques to transmit a portion of an orthogonal frequency-division multiplexing transmission frame comprising a duration field specifying a duration during which an orthogonal frequency division multiplexing device is to refrain from accessing a first frequency sub-band, and use orthogonal frequency division multiple access techniques to transmit a communication frame within the at least first frequency sub-band during the duration specified by the duration field.

In another embodiment of the invention, a method comprises defining at least first and second communication frames for transmission in at least first and second frequency sub-bands, respectively, the at least first and second frequency sub-bands being encompassed within a frequency band, each of the first and second frames comprising a duration field specifying a time duration during which an orthogonal frequency division multiplexing device is to refrain from accessing the sub-bands in which the at least first and second communication frames are transmitted; defining an additional communication frame for transmission in a portion of the frequency band outside the at least first and second frequency sub-bands; transmitting the at least first and second frames using an orthogonal frequency division multiplexing technique; and transmitting the additional communication frame using an orthogonal frequency division multiple access technique.

In another embodiment of the invention, a method comprises receiving at least first and second communication frames transmitted by an access point in at least first and second frequency sub-bands, respectively, the at least first and second frequency sub-bands being encompassed within a frequency band, each of the first and second frames comprising a duration field specifying a time duration during which an orthogonal frequency division multiplexing device is to refrain from accessing the sub-bands in which the at least first and second communication frames are transmitted, and receive an additional communication frame transmitted in a portion of the frequency band outside the at least first and second frequency sub-bands during the duration specified by the duration field, such that transmission of the communication frame is protected from interference by orthogonal frequency division multiplexing devices. The first and second frames are transmitted using an orthogonal frequency division multiplexing technique and the additional communication frame is transmitted using orthogonal frequency division multiple access techniques.

In another embodiment of the invention, a method comprises using orthogonal frequency division multiplexing techniques to transmit a portion of an orthogonal frequency-division multiplexing transmission frame comprising a duration field specifying a duration during which an orthogonal frequency division multiplexing device is to refrain from accessing a first frequency sub-band, and using orthogonal frequency division multiple access techniques to transmit a communication frame during the duration specified by the duration field, such that transmission of the communication frame is protected from interference by orthogonal frequency division multiplexing devices.

In another embodiment of the invention, a computer readable medium stores a program of instructions. Execution of the program of instructions by at least one processor configures an apparatus to at least define at least first and second communication frames for transmission in at least first and second frequency sub-bands, respectively, the at least first and second frequency sub-bands being encompassed within a frequency band, each of the first and second frames comprising a duration field specifying a time duration during which an orthogonal frequency division multiplexing device is to refrain from accessing the sub-bands in which the at least first and second frames are transmitted; define an additional communication frame for transmission in a portion of the frequency band comprising all of the at least first and second frequency sub-bands, transmit the at least first and second frames using an orthogonal frequency division multiplexing technique; and transmit the additional frame using an orthogonal frequency division multiple access technique.

In another embodiment of the invention, a computer readable medium stores a program of instructions. Execution of the program of instructions by at least one processor configures an apparatus to at least receive at least first and second frames transmitted by an access point in at least first and second frequency sub-bands, respectively, the at least first and second frequency sub-bands being encompassed within a frequency band, each of the first and second frames comprising a duration field specifying a time duration during which an orthogonal frequency division multiplexing device is to refrain from accessing the sub-bands in which the at least first and second frames are transmitted, and receive an additional frame transmitted in a portion of the frequency band comprising all of the at least first and second frequency sub-bands during the duration specified by the duration field, such that transmission of the communication frame is protected from interference by orthogonal frequency division multiplexing devices. The first and second frames are transmitted using an orthogonal frequency division multiplexing technique and wherein the additional frame is transmitted using orthogonal frequency division multiple access techniques.

In another embodiment of the invention, a computer readable medium stores a program of instructions. Execution of the program of instructions by at least one processor configures an apparatus to at least use orthogonal frequency division multiple access techniques to transmit a portion of an orthogonal frequency-division multiplexing transmission frame comprising a duration field specifying a duration during which an orthogonal frequency division multiplexing device is to refrain from accessing a first frequency sub-band, and use orthogonal frequency division multiple access techniques to transmit a communication frame within the at least first frequency sub-band during the duration specified by the duration field.

### BRIEF DESCRIPTION OF THE DRAWINGS

FIG. 1 illustrates a wireless network according to an embodiment of the present invention;

FIG. 2 illustrates a signaling scenario according to an embodiment of the present invention;

FIGS. 3-5 illustrate processes according to embodiments of the present invention; and

FIG. 6 illustrates elements that may suitably be used to carry out embodiments of the present invention.

### DETAILED DESCRIPTION

One or more embodiments of the present invention address the expansion of Wifi standards to support access by multiple users. Newly developed standards allow wider bandwidths for signal transmission that include 40/80/160 MHz modes and employ a form of channel bonding to increase data rates. Prior-art applications provide for orthogonal frequency division multiplexing (OFDM) and an access point (AP) using such techniques support only a single user at a time—that is, the transmission is a single user OFDM transmission. In an environment in which smaller data packets are called fork, or the number of users is large, the advantages of higher bandwidth are diminished or eliminated because of the need for repeated condition for channel access. Embodiments of the present invention are directed to the support of orthogonal frequency division multiple access (OFDMA) The use of OFDMA provides a number of advantages, such as gains due to multi-user diversity, reduced overhead for smaller packet, and the ability to better serve heterogeneous nodes (such as legacy 20 MHz or low power nodes, for example).

In one or more embodiments, the invention addresses service to legacy (OFDM) nodes by Will systems that provide OFDMA service, allowing for OFDMA basic service sets (BSSs) to operate on the same frequency band with legacy OFDM basic service sets. Wifi operation in OFDMA requires the introduction of scheduled transmissions in in order to assign OFDMA resources and maintain the necessary synchronization to avoid collisions and reduce interference. On the uplink side this issue is of particular importance since Wifi is a time-duplex system. It is important for the transmission schedule to be strictly adhered to.

However, legacy Wifi systems do not use scheduled transmission and in a mixed environment, legacy systems using unscheduled transmission can interfere with transmissions by OFDMA systems using scheduled transmission. One or more embodiments of the present invention therefore provide mechanisms to direct legacy systems to refrain from accessing particular frequency ranges (for example, to refrain from accessing specified frequency ranges during a specified duration, or to completely refrain from transmission during the specified duration) while OFDMA operation is in progress.

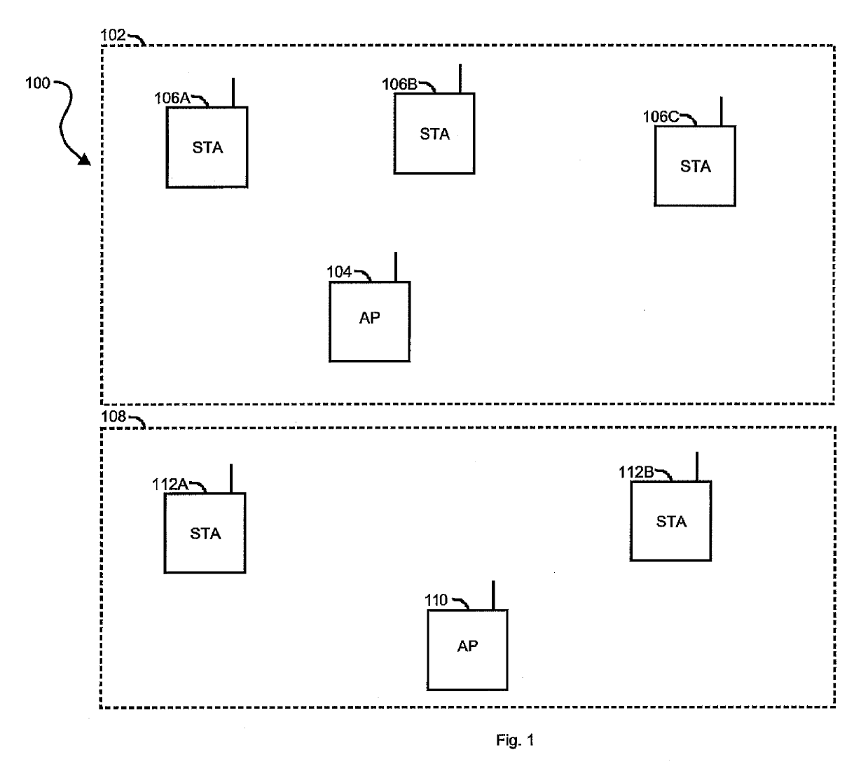

FIG. 1 illustrates a wireless local area network (WLAN) environment 100 according to an embodiment of the present invention. Operating in the WLAN environment 100 is an OFDMA BSS 102 comprising an OFDMA access point (AP) 104 serving stations (STAs 106A-106C). Also operating in the environment 100 are an OFDM BSS 108, comprising an OFDM AP 110, serving STAs 112A and 112B.

The OFDMA AP 104 achieves resource allocation through a network allocation vector (NAV), and one or more embodiments of the invention provide mechanisms to communicate network allocation vector information between an AP (such as the AP 104) and STAs (such as the STAs 106A-106C) while providing information for legacy STAs such as the STAs 112A and 112B that allows them to recognize when they should refrain from transmission, in order to avoid interference with scheduled OFDMA transmission.

In one or more embodiments, an NAV on a Wifi channel may be set in a cooperative fashion when multiple users are allocated different frequency ranges in that channel. In one or more alternative embodiments of the invention, a single STA may be assigned on a per group basis to transmit legacy NAV signals.

To allow for OFDMA BSSs and legacy OFDM BSSs to operate on the same frequency band, one or more embodiments of the present invention allow for the transmission of preamble information during OFDMA transmission. This preamble information can be read by legacy OFDM nodes. In one embodiment, in the downlink direction, the AP may send a legacy preamble that comprises a legacy physical layer convergence protocol (PLCP) header and a legacy media access control (MAC) header, including a duration field to set the network allocation vector within each channel within a frequency band. The channels may, for example, be 20 MHz channels within an 80 MHz frequency band. After the legacy preamble, the AP may send a new allocation frame and OFDMA transmissions (data frames) to a plurality of users.

In one embodiment of the invention, in the uplink direction, before sending any uplink OFDMA transmissions, users send a legacy preamble (comprising a PLCP and MAC header) within each channel. As described below, each OFDMA user allocated to a channel may sent its own portion of the legacy preamble. In another embodiment of the invention, a group leader may be selected to send a legacy header.

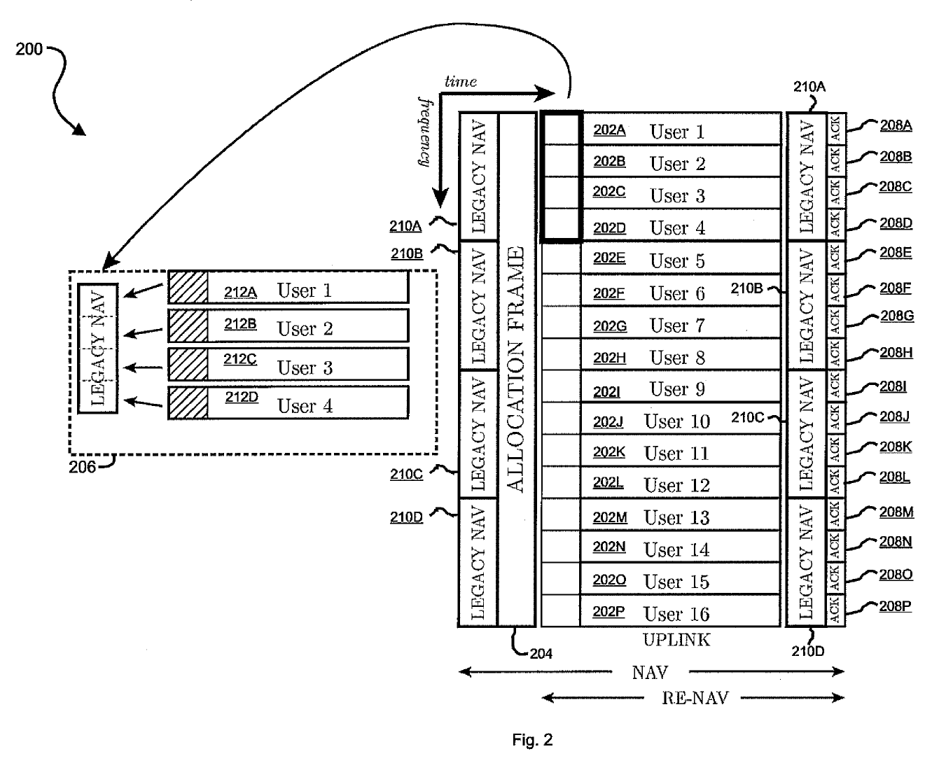

FIG. 2 illustrates a configuration 200 of users and frequency resources. Users are served by an AP, and the AP may employ a frequency band to be used for communication. Sub-bands within this frequency band may be employed for transmission of header information, and other sub-bands may be used for data transmission. Sub-bands may take the form of channels. For example, users 202A-202P share a 20 MHz channel, which may be used for uplink or downlink transmission.

An allocation frame set 204 is used to provide network allocation vector information to users. The frame set 204 may be a set of OFDMA frames. In the case of downlink transmission, a full legacy header, that is, an OFDM header, may be prepended to the OFDMA frame set so that any legacy node receiving the frame set is able to decode the header and set the network allocation vector as appropriate.

In one or more embodiments of the invention, the frequency band used by the AP may be, for example, an 80 MHz frequency band. The sub-bands used for header information may be referred to as first and second sub-bands, which may be 20 MHz channels within the frequency band. The header information may be sent in first and second frames in the first and second sub-bands, respectively. Specifically, the first and second frames may comprise legacy preambles that can be decoded by an OFDM device. The first and second frames may carry information for at least one of a PLCP header and a MAC header. The header information may comprise a duration field specifying a time during which legacy (OFDM) devices should not transmit. Such an approach allows for protection of OFDMA transmission during the specified duration, because the duration field will be able to be decoded by OFDM devices within range. It will be recognized that the reference to “first and second” sub-bands and to “20 MHz” channels is exemplary only, and the mechanisms described in the various embodiments of the invention are applicable in any number of sub-bands of whatever frequency range. For example, four STAs might select four sub-bands of 20 MHz each, with a transmission thus appearing as an 80 MHz transmission. As another example, a configuration may be chosen such that the sub-bands are less than (or more than) 20 MHz in extent. Choosing smaller sub-bands, for example, provides for greater granularity. and in one example, four STAs might select sub-bands of 5 MHz each, and a transmission would then appear as a 20 MHz legacy transmission. In the case of uplink transmission (the sending of data or ACKs to the AP by one or more users), one or more embodiments of the present invention provide mechanisms to address the possibility that each of multiple users is transmitting on one of several orthogonal sub-bands in the 20 MHz Wifi native channel. In one or more embodiments of the invention, an AP is aware of the uplink buffer status of the various users 202A-202P, and sends a broadcast frame (the allocation frame 204) to schedule uplink OFDMA operation. The allocation may suitably contain an uplink sub-band assignment for each user as well as any other control information that may be deemed necessary for OFDMA uplink operation.

The users sending uplink data must facilitate channel estimation at the AP for uplink packets. One way in which this may occur is to perform preamble based channel estimation, as is performed in prior art Wifi operation. One simple way to allow for such estimation is for each uplink user to send the required portion of the preamble corresponding to the sub-band assigned to it.

For simplicity, scheduling operation for a single uplink cycle is discussed here. It will be recognized, however, that OFDMA scheduling may encompass multiple transmission time intervals (TTIs) arranged one after another, where some may be uplink users and others may be downlink users. For that reason, periodic recomputation of network allocation vectors during an OFDMA operation ensures that no hidden nodes interfere with the uplink/downlink transmission.

In one embodiment of the invention, a mechanism is provided for partial network allocation vector concatenation, so that multiple users may perform transmissions of partial OFDM frames using OFDMA, to transmit together a single OFDM frame. Each node attempting to send uplink traffic (including an ACK sent in response to a downlink packet) prepends its own OFDMA frame with a portion of the legacy header. This arrangement can be seen in FIG. 2, with the ACKS 208A-208P and the legacy NAVs (210A-210D). The portion of the legacy header will be selected such that a legacy node overhearing the simultaneous uplink transmissions is able to receive a full legacy header. In the scenario illustrated in FIG. 2, the users 202A-202D are simultaneously transmitting, with each transmitting a portion of a legacy header. These portions are concatenated into a full legacy header which can be read by the legacy users 210A-210D. This approach insures that the NAV is frequency communicated from the OFDMA nodes to any overhearing legacy nodes, so that the legacy nodes are aware that they should refrain from transmission. In this way, unnecessary collisions between legacy and 802.11ax networks are prevented. In addition, the appending of the relevant portion of the preamble to the uplink transmission allows for channel estimation at the AP, as is required for OFDM reception.

In an embodiment, a plurality of the users 202A-202P share a channel or a sub-channel by transmitting in OFDMA sub-carriers allocated to them. As an example, 202A-202D transmissions may be performed in a same sub-channel, but each using different sub-carriers. ACKS 208A-208P may share the channel in a similar way.

In an alternative embodiment of the invention, the allocation frame may provide an indication by the AP as to which STAs are to transmit the NAV for each specific channel. In the allocation frame, a single user (or multiple users) may be assigned to transmit the full NAV for that given channel. In the arrangement illustrated in FIG. 2, for example, the users 202A, 202G, 202K, and 202P might be assigned to transmit the legacy header in their respective channels). This assignment can be done in two ways:

If the same users are typically served in a given channel, a group leader can be selected from those users. The group leader will be responsible for transmitting the legacy portion of the header. This approach allows for savings in terms of signaling overhead since the assignment can change infrequently and not be included in every allocation frame.

If greater flexibility is desired, it will be possible for the AP to explicitly indicate which STA should transmit the legacy header in each channel. The benefit of this approach is greater flexibility during the scheduling period. In addition, by cycling through various users, the AP could use the legacy header to periodically obtain the channel estimate from the associated users.

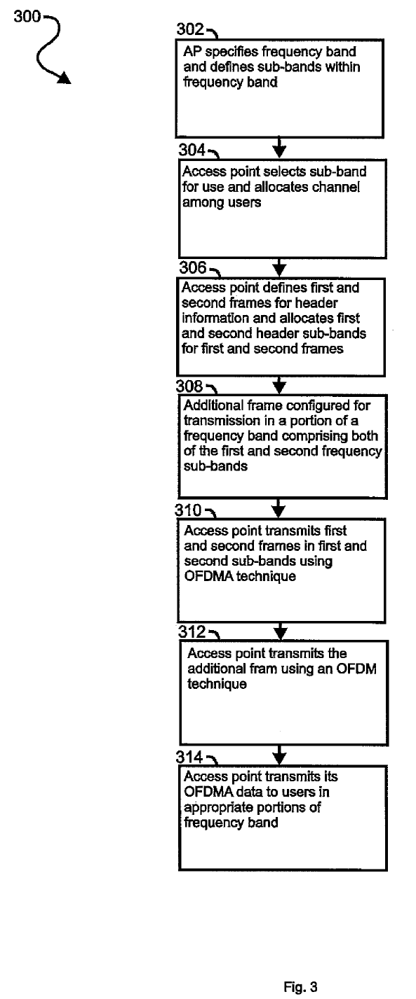

FIG. 3 illustrates a process 300 for downlink OFDMA transmission according to an embodiment of the present invention. At block 302, a Wifi access point (AP) specifies a frequency band for use in communication and defines sub-bands within the frequency band. For example, the frequency band may be an 80 MHz band which may be divided into 20 MHz sub-bands. At block 304, the access point selects one of the sub-bands for a user channel and allocates the channel among users. At block 306, the access point defines first and second frames for header information and allocates first and second header sub-bands for the first and second frames, respectively. First and second frames and first and second sub-bands are described here by way of illustration, but it will be recognized that any desired number of frames or sub-bands may be used. In the illustrated example, each of the first and second frames may define a duration field specifying a duration during which an OFDM device should refrain from transmission. The frames may take the form of OFDM headers, so that a legacy (OFDM) device within range will be able to read the frames and recognize that it should refrain from transmission for the specified duration.

At block 308, an additional frame is configured for transmission in a portion of the frequency band comprising both of the first and second frequency sub-bands. The additional communication frame may be an allocation frame for a set or group of devices, such as WLAN STAs.

At block 310, the access point transmits the first and second frames in the first and second sub-bands, and at block 312, the access point transmits the additional frame using an orthogonal frequency division multiplexing technique. At block 314, the access point transmits its OFDMA data to users in appropriate portions of the frequency band.

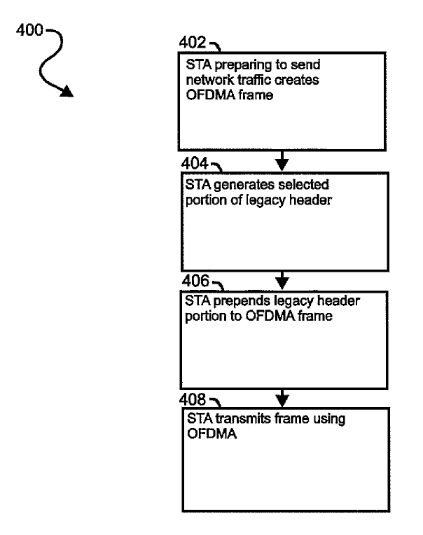

FIG. 4 illustrates a process 400 for uplink OFDMA transmission, according to an embodiment of the present invention. The process 400 may be employed in conjunction with the process 400, and it will be recognized that separating uplink and downlink into separate processes is being done simply for clarity of discussion, and that in operation uplink and downlink are performed as needed. The process 400 may be presumed to follow block 302 of the process 300, because the same channel division and allocation are employed for uplink and downlink operation. At block 402, a user node (STA) preparing to send uplink traffic creates an OFDMA frame. The OFDMA frame may be the node's own traffic or an acknowledgement (ACK) sent in response to a transmission from the access point. At block 404, the user node generates a selected portion of a legacy header, with the legacy header portion being configured in coordination with other nodes preparing to transmit on the uplink, such that transmission by all of the nodes will produce a full legacy header. In this way, a legacy node overhearing the simultaneous uplink transmissions in the channel is able to receive a full legacy header. At block 406, the user node prepends the legacy header portion to its OFDMA frame, and at block 408, the user node performs transmission simultaneously with any other user nodes performing OFDMA transmission on the same uplink. These user nodes have also prepared their own legacy header portions.

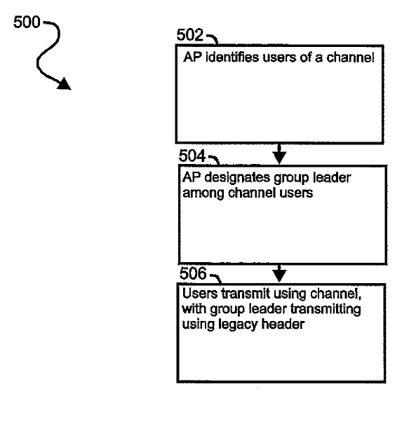

FIG. 5 illustrates an alternative process 500 of uplink transmission according to an embodiment of the present invention. Similarly to the process 400, the process 500 may be performed in coordination with the process 300. At block 502, the AP identifies the users of a channel. At block 504, the AP designates a group leader from among the users of the channel. The group leader is responsible for transmitting a legacy header during each uplink use of the channel. Depending on which users are generally served by the channel, the AP may designate a group leader only infrequently (if the same users are generally served by the channel) or may designate the group leader with each use of the channel. One approach to designating a group leader is to rotate through users. Such an approach makes it easier for the AP to estimate the channel from STAs, because transmissions from each STA are available and the AP can estimate transmission quality of the legacy header from each STA. At block 506, the STAs transmit using the channel, with the designated group leader transmitting the legacy header.

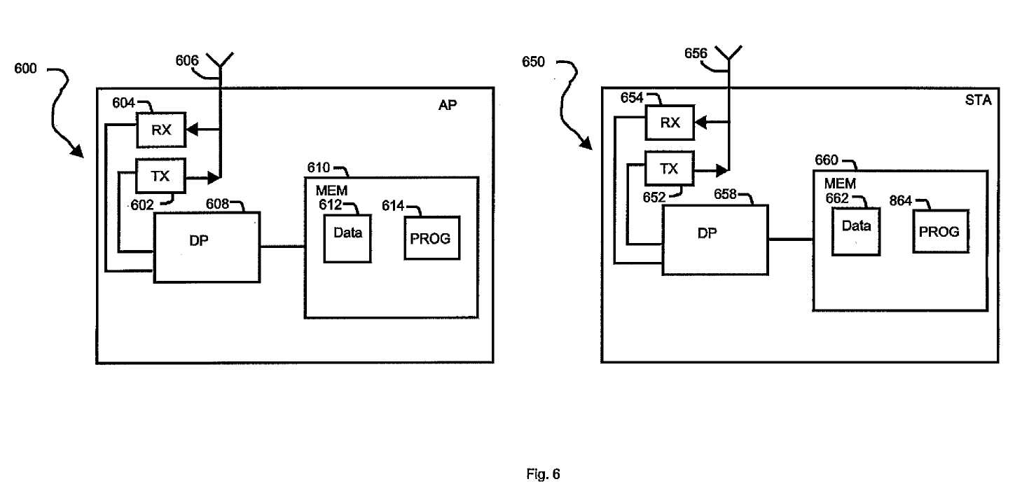

FIG. 6 presents details of an AP 600, and a STA 650, suitable for carrying out one or more embodiments of the present invention. APs similar to the AP 600 may be implemented as, for example, the AP 102 of FIG. 1. The AP 600 may suitably comprise a transmitter 602, receiver 604, and antenna 606. The AP 600 may also include a processor 608 and memory 610. The AP 600 may employ data 612 and programs (PROGS) 614, residing in memory 610.

The STA 650 may suitably comprise a transmitter 652, receiver 654, and antenna 656. The STA 650 may also include a processor 658 and memory 660. The STA 650 may employ data 662 and programs (PROGS) 664, residing in memory 660.

At least one of the PROGs 614 in the AP 600 is assumed to include a set of program instructions that, when executed by the associated DP 608, enable the device to operate in accordance with embodiments of this invention. In these regards, embodiments of this invention may be implemented at least in part by computer software stored on the MEM 610, which is executable by the DP 608 of the AP 600, or by hardware, or by a combination of tangibly stored software and hardware (and tangibly stored firmware). Similarly, at least one of the PROGs 664 in the STA 650 is assumed to include a set of program instructions that, when executed by the associated DP 658, enable the device to operate in accordance with the exemplary embodiments of this invention, as detailed above. In these regards, embodiments of this invention may be implemented at least in part by computer software stored on the MEM 660, which is executable by the DP 658 of the STA 650, or by hardware, or by a combination of tangibly stored software and hardware (and tangibly stored firmware). Electronic devices implementing these aspects of the invention need not be the entire devices as depicted at FIG. 1 or FIG. 6 or may be one or more components of same such as the above described tangibly stored software, hardware, firmware and DP, or a system on a chip SOC or an application specific integrated circuit ASIC.

In general, the various embodiments of the STA 650 can include, but are not limited to personal portable digital devices having wireless communication capabilities, including but not limited to cellular telephones, navigation devices, laptop/palmtop/tablet computers, digital cameras and music devices, and Internet appliances.

Various embodiments of the computer readable MEM 610 and 660 include any data storage technology type which is suitable to the local technical environment, including but not limited to semiconductor based memory devices, magnetic memory devices and systems, optical memory devices and systems, fixed memory, removable memory, disc memory, flash memory, DRAM, SRAM, EEPROM and the like. Various embodiments of the DP 608 and 658 include but are not limited to general purpose computers, special purpose computers, microprocessors, digital signal processors (DSPs) and multi-core processors.

Various modifications and adaptations to the foregoing exemplary embodiments of this invention may become apparent to those skilled in the relevant arts in view of the foregoing description. While various exemplary embodiments have been described above it should be appreciated that the practice of the invention is not limited to the exemplary embodiments shown and discussed here.

Further, some of the various features of the above non-limiting embodiments may be used to advantage without the corresponding use of other described features. The foregoing description should therefore be considered as merely illustrative of the principles, teachings and exemplary embodiments of this invention, and not in limitation thereof.

Various modifications and adaptations to the foregoing exemplary embodiments of this invention may become apparent to those skilled in the relevant arts in view of the foregoing description. While various exemplary embodiments have been described above it should be appreciated that the practice of the invention is not limited to the exemplary embodiments shown and discussed here.

Further, some of the various features of the above non-limiting embodiments may be used to advantage without the corresponding use of other described features. The foregoing description should therefore be considered as merely illustrative of the principles, teachings and exemplary embodiments of this invention, and not in limitation thereof.

1. An apparatus comprising:
at least one processor;
memory storing a program of instructions;
wherein the memory storing the program of instructions is configured to, with the at least one processor, cause the apparatus to at least:
define at least first and second frames for transmission in at least first and second frequency sub-bands, respectively, the at least first and second frequency sub-bands being encompassed within a frequency band, each of the first and second frames comprising a duration field specifying a time duration during which an orthogonal frequency division multiplexing device is to refrain from accessing the sub-bands in which the at least first and second frames are transmitted;
define an additional frame for transmission in a portion of the frequency hand comprising all of the at least first and second frequency sub-bands;
transmit the at least first and second frames using an orthogonal frequency division multiplexing technique; and
transmit the additional frame using an orthogonal frequency division multiple access technique.

2. The apparatus of claim 1, wherein the at least first and second frames comprise preambles configured to be read by orthogonal frequency division multiplexing devices and comprising information for at least one of a physical layer convergence protocol header and a media access control header.

3. The apparatus of claim 1, wherein the at least first and second frequency sub-bands each have a 20 MHz bandwidth and wherein the frequency band has a bandwidth encompassing multiple 20 MHz frequency bands.

4. An apparatus comprising:
at least one processor;
memory storing a program of instructions;
wherein the memory storing the program of instructions is configured to, with the at least one processor, cause the apparatus to at least:
receive at least first and second frames from an access point in at least first and second frequency sub-bands, respectively, the at least first and second frequency sub-bands being encompassed within a frequency band, each of the first and second frames comprising a duration field specifying a time duration during which an orthogonal frequency division multiplexing device is to refrain from accessing the sub-bands in which the at least first and second frames are received; and
receive an additional frame in a portion of the frequency band comprising all of the at least first and second frequency sub-bands during the duration specified by the duration field;
wherein the first and second frames are received according to an orthogonal frequency division multiplexing technique and wherein the additional frame is received according to orthogonal frequency division multiple access techniques.

5. The apparatus of claim 4, wherein the at least first and second frames comprise preambles configured to be read by orthogonal frequency division multiplexing devices and comprising information for at least one of a physical layer convergence protocol header and a media access control header.

6. The apparatus of claim 4, wherein the at least first and second frequency sub-bands each have a 20 MHz bandwidth and wherein the frequency band has a bandwidth encompassing multiple 20 MHz frequency bands.

7.-11. (canceled)

12. A method comprising:
defining at least first and second frames for transmission in at least first and second frequency sub-bands, respectively, the at least first and second frequency sub-bands being encompassed within a frequency band, each of the first and second frames comprising a duration field specifying a time duration during which an orthogonal frequency division multiplexing device is to refrain from accessing the sub-bands in which the at least first and second frames are transmitted;
defining an additional frame for transmission in a portion of the frequency band comprising all of the at least first and second frequency sub-bands;
transmitting the at least first and second frames using an orthogonal frequency division multiplexing technique; and
transmitting the additional frame using an orthogonal frequency division multiple access technique.

13. The method of claim 12, wherein the at least first and second frames comprise preambles configured to be read by orthogonal frequency division multiplexing devices and comprising information for at least one of a physical layer convergence protocol header and a media access control header.

14. The method of claim 12, wherein the at least first and second frequency sub-bands each have a 20 MHz bandwidth and wherein the frequency band has a bandwidth encompassing multiple 20 MHz frequency bands.

15. A method comprising:
receiving at least first and second frames transmitted by an access point in at least first and second frequency sub-bands, respectively, the at least first and second frequency sub-bands being encompassed within a frequency band, each of the first and second frames comprising a duration field specifying a time duration during which an orthogonal frequency division multiplexmg device is to refrain from accessing the sub-bands in which the at least first and second communication frames are transmitted; and
receiving an additional frame transmitted in a portion of the frequency band comprising the at least first and second frequency sub-bands during the duration specified by the duration field, such that transmission of the communication frame is protected from interference by orthogonal frequency division multiplexmg devices;
wherein the first and second frames are transmitted using an orthogonal frequency division multiplexing technique and wherein the additional frame is transmitted using orthogonal frequency division multiple access techniques.

16. The method of claim 15, wherein the at least first and second frames comprise preambles configured to be read by orthogonal frequency division multiplexing devices and comprising information for at least one of a physical layer convergence protocol header and a media access control header.

17. The method of claim 15, wherein the at least first and second frequency sub-bands each have a 20 MHz bandwidth and wherein the frequency band has a bandwidth encompassing multiple 20 MHz frequency bands.

18.-22. (canceled)

23. A computer readable medium storing a program of instructions, execution of which by at least one processor configures an apparatus to at least:
define at least first and second frames for transmission in at least first and second frequency sub-bands, respectively, the at least first and second frequency sub-bands being encompassed within a frequency band, each of the first and second frames comprising a duration field specifying a time duration during which an orthogonal frequency division multiplexing device is to refrain from accessing the sub-bands in which the at least first and second frames are transmitted;
define an additional frame for transmission in a portion of the frequency band comprising all of the at least first and second frequency sub-bands;
transmit the at least first and second frames using an orthogonal frequency division multiplexing technique; and
transmit the additional frame using an orthogonal frequency division multiple access technique.

24. The computer readable medium of claim 23, wherein the at least first and second frames comprise preambles configured to be read by orthogonal frequency division multiplexing devices and comprising information for at least one of a physical layer convergence protocol header and a media access control header.

25. The computer readable medium of claim 23, wherein the at least first and second frequency sub-bands each have a 20 MHz bandwidth and wherein the frequency band has a bandwidth encompassing multiple 20 MHz frequency bands.

26. A computer readable medium storing a program of instructions, execution of which by at least one processor configures an apparatus to at least:
receive at least first and second frames from an access point in at least first and second frequency sub-bands, respectively, the at least first and second frequency sub-bands being encompassed within a frequency band, each of the first and second frames comprising a duration field specifying a time duration during which an orthogonal frequency division multiplexing device is to refrain from accessing the sub-bands in which the at least first and second frames are received; and
receive an additional frame in a portion of the frequency band comprising all of the at least first and second frequency sub-bands during the duration specified by the duration field;
wherein the first and second frames are received according to an orthogonal frequency division multiplexing technique and wherein the additional communication frame is received according to orthogonal frequency division multiple access techniques.

27. The computer readable medium of claim 26, wherein the at least first and second frames comprise preambles configured to be read by orthogonal frequency division multiplexing devices and comprising information for at least one of a physical layer convergence protocol header and a media access control header.

28. The computer readable medium of claim 26, wherein the at least first and second frequency sub-bands each have a 20 MHz bandwidth and wherein the frequency band has a bandwidth encompassing multiple 20 MHz frequency bands.

29.-33. (canceled)
